(19) United States
(12) Patent Application Publication
(10) Pub. No.: US 2024/0317034 A1
(43) Pub. Date: Sep. 26, 2024

(54) VEHICLE CONSTRUCTION HAVING DETACHABLE ROOF PARTS

(71) Applicant: Webasto SE, Stockdorf (DE)

(72) Inventors: Michael T. Willard, Harrison Township, MI (US); Ryan Mitchell, Novi, MI (US); Jason Bowles, Owosso, MI (US)

(21) Appl. No.: 18/601,501

(22) Filed: Mar. 11, 2024

Related U.S. Application Data
(60) Provisional application No. 63/491,155, filed on Mar. 20, 2023.

(51) Int. Cl. B60J 7/11; B60R 21/13; B60S 1/56

(52) U.S. Cl. CPC B60J 7/11; B60R 21/13; B60S 1/56

(57) ABSTRACT

A motor vehicle, in particular a sport utility vehicle, includes a vehicle body and a vehicle roof. The vehicle roof is connected to the vehicle body in a detachable manner and preferably has a roof frame assembly. The roof frame assembly preferably includes a longitudinal roof rail on either side of a vertical longitudinal center roof plane and at least one transverse roof rail. The vehicle roof and in particular the roof frame assembly is connected to the vehicle body in a detachable manner. The vehicle roof and in particular the roof frame assembly includes at least one environmental sensor for electronically detecting the vehicle environment for the purpose of an autonomous or driver assisted operation of the motor vehicle.

### CROSS-REFERENCE TO RELATED APPLICATION

This application claims the benefit of U.S. Provisional Application No. 63/491,155, filed Mar. 20, 2023, which is incorporated herein by reference in its entirety.

### TECHNICAL FIELD

The invention relates to a motor vehicle, in particular a sport utility vehicle, the motor vehicle comprising a vehicle body and a vehicle roof, the vehicle roof being connected to the vehicle body in a detachable manner.

### BACKGROUND

A motor vehicle of this kind is known from practice and is in particular realized as a sport utility vehicle, which has a vehicle body, which can be considered a vehicle substructure. A vehicle roof can be connected to the vehicle structure via pillars, the vehicle roof forming a rigid roof and having roof elements which are realized as panels and which can be detached from the vehicle structure to form a roof opening and which can also be stored separately from the vehicle.

Furthermore, it is known for a motor vehicle to be provided with environment sensors which enable the motor vehicle in question to drive autonomously, i.e., on its own. The environment sensors, which can be lidar sensors, radar sensors and/or cameras, electronically detect the vehicle surroundings and transmit the obtained measuring signals to a controller interacting with the vehicle controller and the vehicle drive.

### SUMMARY

The invention proposes a motor vehicle, in particular a sport utility vehicle, the motor vehicle comprising a vehicle body and a vehicle roof, the vehicle roof being connected to the vehicle body in a detachable manner and preferably having a roof frame assembly, the roof frame assembly preferably comprising a longitudinal roof rail on either side of a vertical longitudinal center roof plane and at least one transverse roof rail, wherein the vehicle roof and in particular the roof frame assembly is connected to the vehicle body in a detachable manner, wherein the vehicle roof and in particular the roof frame assembly comprises at least one environment sensor for electronically detecting the vehicle environment for the purpose of an autonomous or driver assisting operation of the motor vehicle. The integration of the at least one environment sensor in the vehicle roof, which is connected to the vehicle body in such a manner that an end customer or a vehicle user can easily detach it from the vehicle body, allows the user to decide individually and as needed whether they want the motor vehicle to be able to drive autonomously or sensor-assisted (semi-autonomously) by placing the complete vehicle roof or only the roof frame assembly on the vehicle body or whether they do not wish to use this option and even prefer to drive without the vehicle roof. In a special embodiment, a wind screen of the motor vehicle in question can be pivoted in a storage position, in particular if the vehicle roof is withdrawn, i.e. detached.

The vehicle roof and in particular the roof frame assembly can be connected to or detached from the vehicle body as desired by the user via quick fasteners, which are realized as screwed connections, catch connections, snap-lock connections or the like.

The at least one environment sensor can be integrated into the roof frame assembly in an optically pleasing manner with the result that no additional installation space is required for these structural elements. Since the environment sensor is disposed in the roof frame assembly, it is positioned high on the vehicle structure with the result that the field of view is not obstructed by other vehicle components.

The environment sensor can basically be configured in various ways and can in particular comprise a lidar sensor, a radar sensor, an optical sensor, such as a camera, and/or the like. A lidar sensor preferably operates in a wavelength range of 905 nm or approximately 1550 nm. A camera used as an environment sensor can operate in the wavelength range of visible light and/or in the infrared range.

It is advantageous for the roof frame assembly, which preferably limits the vehicle roof on at least three sides, to comprise multiple environment sensors so that the motor vehicle in question has a good 360° view for an autonomous driving mode. For example, at least one environment sensor is disposed on a front transverse rail, which forms a front header of the motor vehicle, and at least one environment sensor is disposed on each of the two longitudinal roof rails. Preferably, one environment sensor is also disposed on a transverse roof rail, which limits the vehicle roof at the rear edge and which is also part of the roof frame assembly, so that the motor vehicle can also detect the vehicle environment in the rear direction.

The rear transverse roof rail, in particular, can be provided with pillars attached to the vehicle body in a detachable manner.

In a preferred embodiment, the roof frame assembly comprises means for cleaning a sensor see-through area of the environment sensor so as to ensure an uninterrupted operation of the at least environment sensor. Moreover, it is advantageous for the roof frame assembly to comprise means for cooling and/or heating the environment sensor so that the environment sensor can be kept at a suitable operating temperature at all times.

It may be advantageous for the roof frame assembly to be disposed on a rollover protection structure attached to the vehicle body in a rigid, i.e., non-detachable, manner so that the roof frame assembly is clearly oriented relative to the vehicle body

### BRIEF DESCRIPTION OF DRAWINGS

An exemplary embodiment of a motor vehicle according to the invention is schematically illustrated in the drawing.

FIG. 1 shows a motor vehicle according to the invention, which is realized as a sport utility vehicle;

FIG. 2 shows a vehicle body of the motor vehicle of FIG. 1 together with vehicle roof parts detached from the vehicle body;

FIG. 3 shows the assembled motor vehicle of FIG. 1 and the parts of a roof frame assembly that can be detached from the vehicle body; and

FIG. 4 is a top view of the vehicle roof.

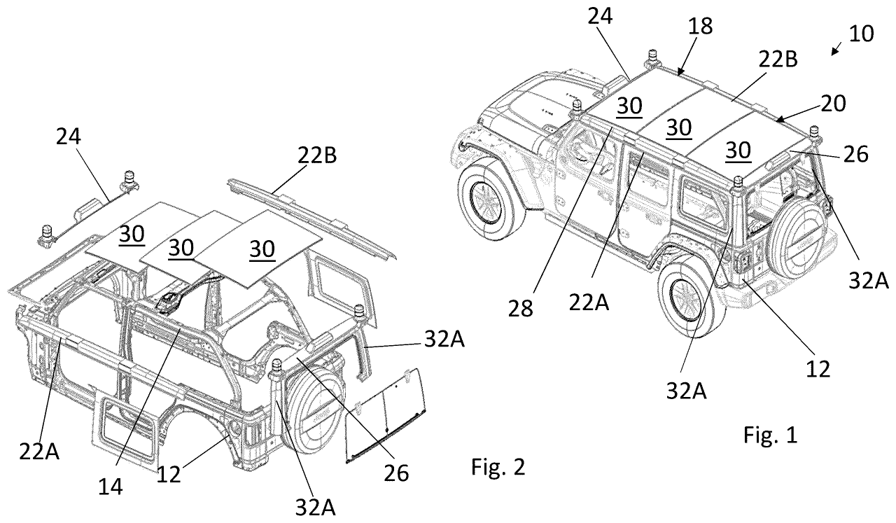

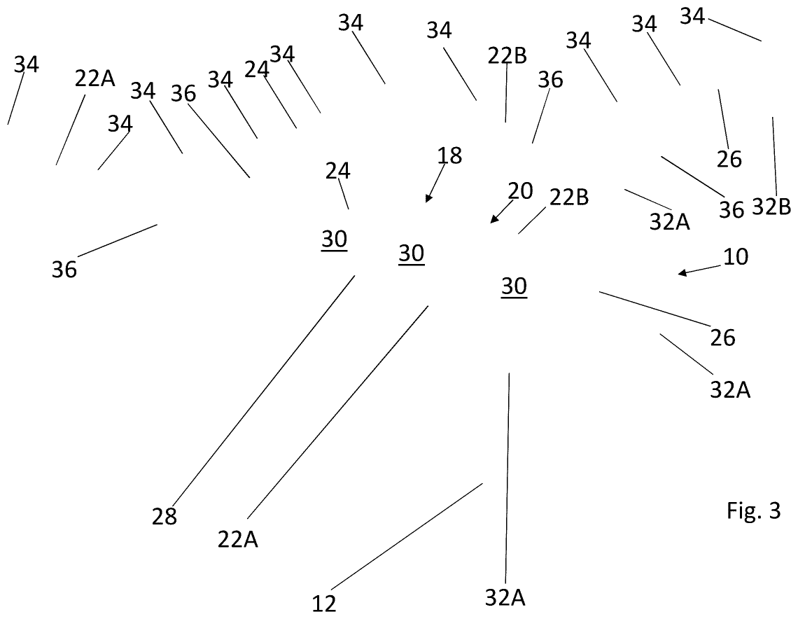

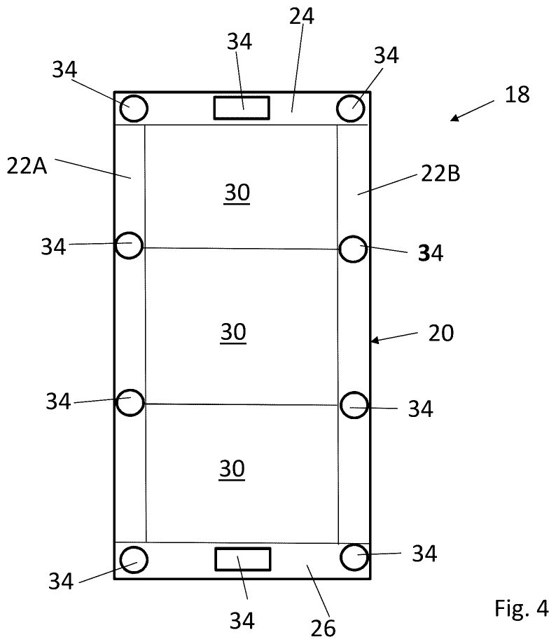

### DETAILED DESCRIPTION

The drawing shows a motor vehicle 10, which is realized as a sport utility vehicle and, as can be seen in FIG. 2 in particular, comprises a vehicle body 12, which forms a vehicle substructure and is provided with a roll cage 14, which surrounds a vehicle interior 16 in the manner of a cage. In addition to trim parts, doors, drive elements and the typical parts of the vehicle interior, motor vehicle 10 comprises a vehicle roof 18, which has a roof frame assembly 20, which comprises a longitudinal roof rail 22A or 22B on either side of a vertical longitudinal center vehicle plane and a front transverse roof rail 24, which forms a front header, and a rear transverse roof rail 26, which forms a rear edge of vehicle roof 18. Roof frame assembly 20 surrounds a roof opening 28, which is filled with roof panels 30, which can be detached individually and can be separated from the vehicle structure, roof panels 30 being disposed one behind the other in the longitudinal vehicle direction.

Roof frame assembly 20 is connected to roll cage 14 via a fastening device. The fastening device, which can comprise a screwed connection, a snap-lock connection and/or a catch connection, can be operated by the user manually or by means of a suitable specialized tool, which is easy to handle. Rear transverse roof rail 26 comprises two almost vertical pillars 32A and 32B, which are each placed on top of vehicle body 12 in a rear corner area and can be detached by a user without tools or by means of a suitable specialized tool, which is easy to handle.

Front transverse roof rail 24 comprises three environment sensors 34, which are lidar sensors, radar sensors and/or cameras and which can be electrically connected to a controller of motor vehicle 10 via suitable cables 36. The two longitudinal roof rails 22A and 22B each comprise two environment sensors 34, which can also be connected to the controller of motor vehicle 10 via respective cables 36. Likewise, rear transverse roof rail 26 comprises three environment sensors 34, which are connected to the controller of motor vehicle 10 via cables 36.

### REFERENCE SIGNS

10 motor vehicle
12 vehicle body
14 roll cage
16 vehicle interior
18 vehicle roof
20 roof frame assembly
22A, B longitudinal roof rail
24 transverse roof rail
26 transverse roof rail
28 roof opening
30 roof panel
32A, B pillar
34 environmental sensor
36 cables

1. A motor vehicle, comprising a vehicle body and a vehicle roof, the vehicle roof being connected to the vehicle body in a detachable manner, wherein the vehicle roof and in particular the roof frame assembly is connected to the vehicle body in a detachable manner, wherein the vehicle roof and in particular the roof frame assembly comprises at least one environmental sensor for electronically detecting the vehicle environment for the purpose of an autonomous or driver assisted operation of the motor vehicle.

2. The motor vehicle according to claim 1, wherein the transverse roof rail is provided with pillars attached to the vehicle body in a detachable manner.

3. The motor vehicle according to claim 1, wherein the transverse roof rail forms a front header of the motor vehicle.

4. The motor vehicle according to claim 1, wherein the roof frame assembly comprises means for cleaning a sensor see-through area of the environmental sensor.

5. The motor vehicle according to claim 1, wherein the roof frame assembly comprises means for cooling and/or heating the environmental sensor.

6. The motor vehicle according to claim 1, wherein the roof frame assembly is disposed on top of a rollover protection structure connected to the vehicle body in a rigid and non-detachable manner.

7. The motor vehicle according to claim 1, wherein the motor vehicle is a sport utility vehicle.

8. The motor vehicle according to claim 1, wherein the vehicle roof comprises a roof frame assembly, the roof frame assembly comprising a longitudinal roof rail on either side of a vertical longitudinal center roof plane and at least one transverse roof rail.

9. The motor vehicle according to claim 8, wherein the roof frame assembly comprises the at least one environmental sensor.
